(19) United States
(12) Patent Application Publication
(10) Pub. No.: US 2023/0227376 A1
(43) Pub. Date: Jul. 20, 2023

(54) METHODS FOR PRODUCING UREA CALCIUM SULFATE FROM MOIST PHOSPHOGYPSUM

(71) Applicant: SABIC Global Technologies B.V., Bergen op Zoom (NL)

(72) Inventors: Andrew George KELLS, Wilton (GB); Nilkamal BAG, Bangalore (IN); Saleh AL-SHAMMARI, Riyadh (SA); Rajamalleswaramma KORIPELLY, Bangalore (IN)

(73) Assignee: SABIC Global Technologies B.V., Bergen op Zoom (NL)

(21) Appl. No.: 18/002,452

(22) PCT Filed: Jun. 29, 2021
(86) PCT No.: PCT/IB2021/055818

§ 371 Date: Dec. 19, 2022

(30) Foreign Application Priority Data
Jul. 1, 2020 (IN) 202011027948

(51) Int. Cl. C05C 7/02

(52) U.S. Cl. CPC C05C 7/02

(57) ABSTRACT

Method for producing a urea calcium sulfate (UCS) adduct is disclosed. The method for producing the UCS adduct, includes contacting urea with a moist phosphogypsum containing 10 wt. % to 30 wt. % of moisture, under conditions sufficient to form a slurry comprising formed UCS adduct.

### CROSS REFERENCE TO RELATED APPLICATIONS

This application claims priority to and the benefit of priority of Indian Provisional Application No. 202011027948, filed Jul. 1, 2020, which is hereby incorporated by reference in its entirety.

### BACKGROUND OF THE INVENTION

### A. Field of the Invention

The invention generally concerns methods for producing urea calcium sulfate (UCS) adduct from phosphogypsum. The method can include contacting urea with a moist phosphogypsum, the phosphogypsum containing 10 wt. % to 30 wt. % of moisture, under conditions sufficient to form a slurry containing a UCS adduct.

### B. Description of Related Art

Soil nutrients, such as nitrogen, phosphorus, potassium, and sulfur, as well as trace elements such as iron, zinc, copper, and magnesium, are useful for achieving thriving agriculture and growth of plants. Upon repeated planting cycles, the quantity of these nutrients in the soil may be depleted, resulting in inhibited plant growth and decreased production. To counter this effect, fertilizers have been developed to help replace the depleted vital nutrients. Single-nutrient fertilizers and multi-nutrient fertilizers, such as fertilizer blends, have been developed to meet the varied needs of crop production worldwide.

Fertilizers containing nitrogen are used to support healthy plant growth and photosynthesis. Urea (CH₄N₂O) is a compound that contains nitrogen and is widely used as a nitrogen source in fertilizers. However, due to its rapid hydrolysis and nitrification in the soil, nitrogen from urea can be quickly lost. Also, using urea in fertilizer blends that contain other soil nutrients is difficult, as urea can undesirably react with other components in the fertilizer, such as organic fertilizers. These reactions can produce water that liquefies solid granules or dry mixture products, cause clumping and loss of product, and increase the rate at which these undesirable reactions take place. See Biskupski et al. (EP 2,774,907); see also Achard et al. (U.S. Pat. No. 5,409,516). Further, the production of water increases the amount of water that has to be removed during production of urea containing fertilizers, making these blended fertilizers difficult and more expensive to make. See Schwob (FR 2,684,372).

Some of the problems with using urea in fertilizers have been reduced by binding urea to calcium sulfate as a calcium sulfate urea adduct (UCS) or reacting urea with rock phosphate and sulfuric acid to form urea associated with superphosphate (monocalcium phosphate; Ca(H₂PO₄)₂) and/or dicalcium phosphate (CaHPO₄) (see WO 01/42172, WO 19/016761, CN108530175, CN103086781, CN103086810, EP2774907, U.S. Pat. Nos. 2,074,880, 4,283,423, 5,409,516, GB1189398, Achard et al. Phosphorus and potassium 191 (1994): 27-33, Whittaker et al. Ind. Eng. Chem. 1933, 25, 11, 1280-1282, Malinowski et al. Polish Journal of Chemical Technology 9, no. 4 (2007): 111-114).

However, difficulties still exist for large scale commercial manufacture of UCS adduct. For example, presence of higher or lower amount of moisture in slurries used to produce UCS adduct can hinder UCS adduct formation or can make the slurry difficult to handle and/or further process. Further, UCS adduct can be produced from phosphogypsum produced as a byproduct during phosphoric acid manufacturing. However considerable energy is required to heat the phosphogypsum and the addition of large amounts of water is required for the reaction, since phosphogypsum produced from phosphoric acid manufacturing is disposed or stored as dry crystalline stacks.

### SUMMARY OF THE INVENTION

A discovery has been made that provides a solution to at least some of the problems associated with production of calcium sulfate urea (UCS) adduct (4NH₂CONH₂·CaSO₄) based fertilizers. In one aspect, the solution includes producing UCS adduct from moist phosphogypsum. Moist phosphogypsum obtained relatively freshly from a phosphoric acid manufacturing plant can have a higher amount of moisture and temperature, desired for UCS adduct formation, compared to phosphogypsum that has been dried and cooled, for example to form dry crystalline stacks. Less energy and less additionally added water are required to produce UCS adduct from moist phosphogypsum compared to phosphogypsum that has been dried and cooled. Further moist phosphogypsum can have residual P₂O₅ and relatively low pH, which can improve UCS adduct formation through urea volatilization, and increase UCS adduct weight percentage in the fertilizer produced. The UCS fertilizer granule product produced after drying the produced UCS adduct can be used as a high nitrogen content fertilizer. The fertilizer compositions can be beneficial where higher concentrations of nitrogen are desired.

In one aspect of the invention, a method to produce an UCS adduct is described. The method can include step (a). In step (a) urea can be contacted with a moist phosphogypsum containing 10 wt. % to 30 wt. % of moisture, under conditions sufficient to form a slurry containing a UCS adduct. The UCS adduct can be CaSO₄·4CO(NH₂)₂. In some aspects, an aqueous urea solution can be contacted with the moist phosphogypsum to form the slurry. In some aspects, the aqueous urea solution can include 10 wt. % to 30 wt. % of water. In some aspects, urea particles having a size of 0.1 mm to 1 mm can be contacted with the moist phosphogypsum to form the slurry. In some aspects, urea granules and/or prills having a size of 1 mm to 4 mm can be contacted with the moist phosphogypsum to form the slurry. In some aspects, the contacting conditions in step (a) can include a temperature of 40° C. to 80° C. In some aspects, the moist phosphogypsum contacting the urea can have a temperature of 30° C. to 60° C. The moist phosphogypsum can be obtained from a phosphoric acid manufacturing plant. In some aspects, the moist phosphogypsum from the phosphoric acid manufacturing plant is not dried and/or pretreated to reduce moisture content of phosphogypsum below 10 wt. % prior to contacting the urea in step (a) and/or no water is added to the moist phosphogypsum produced from the phosphoric acid manufacturing plant after production of the phosphogypsum or in the contacting step (a) other than the water contained in the moist phosphogypsum from the phosphoric acid manufacturing plant. In some aspects, the moist phosphogypsum from the phosphoric acid manufacturing plant is not cooled, such as to a temperature below 30° C., prior to contacting the urea in step (a). The moist phosphogypsum can be a freshly produced moist phosphogypsum having a moisture content of 10 wt. % to 30 wt. % or 15 wt. % to 30 wt. % and a temperature of 30° C. to 60° C. The freshly produced moist phosphogypsum after being formed in the phosphoric acid production plant is not pretreated, e.g. dried to reduce moisture content below 10 wt. % and/or cooled to a temperature below 30° C. after being produced and prior to contacting the moist phosphogypsum with urea to form the slurry. In some aspects, the molar ratio of urea to calcium sulfate contained in the phosphogypsum contacted in step (a) can be 1:0.25 to 1.2:0.16.

The slurry and/or product produced by the methods herein, can optionally contain a urease inhibitor and/or a base. In some instances, the urease inhibitor and/or the base can be added to the slurry formed by contacting urea with the moist phosphogypsum. In some instances, the UCS adduct produced by the methods herein, the urea, and/or the moist phosphogypsum are contacted with the urease inhibitor and/or the base before, during, or after formation of the slurry. The base can contain an oxide, carbonate, acetate, and/or hydroxide of a group 1 metal, group 2 metal, group 13 metal, and/or ammonium. In certain aspects, the base can contain CaO and/or MgO. In certain particular aspects, the base can be MgO. In certain aspects, the base such as MgO can be comprised in particulate solids. In certain aspects, the particulate solids can have an average diameter of 0.1 μm to 150 μm or 1 μm to 50 μm. In certain aspects, the urease inhibitor can contain a thiophosphoric triamide derivative or phenyl phosphorodiamidate (PPDA). In certain aspects, the thiophosphoric triamide derivative can be N-(n-butyl) thiophosphoric triamide (NBPT).

In some aspects, the method can further include step (b), where in step (b) the slurry can be dried to form a dried fertilizer composition containing the formed UCS adduct. In some aspects, the dried fertilizer composition formed in step (b) can contain 0 wt. % to 10 wt. %, or 0 wt. % to 2 wt. %, or 2 wt. % to 10 wt. % of moisture. In some aspects, the slurry can be dried by contacting the slurry or vessel used for drying the slurry with steam. The slurry can be dried in the same vessel used for step (a) or in a different vessel. The vessel used to dry the slurry and produce the dried fertilizer composition can be a dryer. In some aspects, the slurry can be dried at 35° C., 40° C., 45° C., 50° C., 55° C., 60° C., 65° C., 70° C., 75° C., 80° C., 85° C., 90° C., 95° C., 100° C. or greater, or any temperature or range thereof or there between. In some aspects, 40 wt. % to 95 wt. % of the dried fertilizer composition can be comprised of the formed UCS adduct. The dried fertilizer composition can optionally contain 0.2 wt. % to 7 wt. % of a base, such as MgO. The dried fertilizer composition can optionally contain 0.01 wt. % to 0.2 wt. % of a urease inhibitor, such as NBPT. In some particular aspects, 55 wt. % to 95 wt. % of the dried fertilizer composition can be comprised of the formed UCS adduct. In some aspects, the formed UCS adduct can be granulated before, during, and/or after drying the slurry. In some particular aspects, the dried fertilizer composition containing the formed UCS adduct can be granulated to form a granulated fertilizer composition containing the formed UCS adduct. The granulated fertilizer composition can contain UCS fertilizer granules containing the formed UCS adduct. In some aspects, the dried fertilizer composition can be ungranulated, such as in a Run-of-Pile form. Granulation can be performed in a granulator. The step (a) can be performed in a vessel that is the same or different from the granulator in which granulation of the formed UCS adduct is performed. In some aspects, step (a) can be performed in a vessel different from the granulator in which granulation of the formed UCS adduct is performed. In some aspects, the granulation can include contacting the formed UCS adduct, such as the dried fertilizer composition containing the formed UCS adduct, or the vessel used for granulation with steam. In some aspects, the formed UCS adduct, such as the dried fertilizer composition containing the formed UCS adduct, can be stored before granulation. The storing step can include not heating or mixing the dried fertilizer composition containing the UCS adduct. Storing can include storage for 1 minute to several months to years, or any range or time therein. In some aspects, the method can further include combining the formed UCS adduct with additional urea, additional calcium sulfate, and/or additional UCS adduct. In some aspects, the additional urea, additional calcium sulfate, and/or additional UCS adduct can be combined with the slurry, the dried fertilizer composition, and/or the granulated fertilizer composition. In some aspects, the method can further include combining the formed UCS adduct with at least one additional fertilizer to form a fertilizer blend and/or compounded fertilizer. In some particular aspects, the slurry, the dried fertilizer composition, and/or granulated fertilizer composition can be combined with the at least one additional fertilizer to form the fertilizer blend and/or compounded fertilizer.

The additional fertilizer can be a fertilizer, compound, or composition that provides a nitrogen based fertilizer, a phosphate-based fertilizer, a potassium-based fertilizer, a urea-based fertilizer, a fertilizer providing nitrogen-phosphorus-potassium (NPK), diammonium phosphate (DAP), monoammonium phosphate (MAP), single superphosphate (SSP), triple superphosphate (TSP), urea, potassium chloride, potassium sulfate, magnesium sulfate, superphosphates, rock phosphate, potash, sulfate of potash (SOP), muriate of potash (MOP), kieserite, carnallite, magnesite, dolomite, boric acid, boron (B), copper (Cu), iron (Fe), manganese (Mn), molybdenum (Mo), zinc (Zn), selenium (Se), silicon (Si), free calcium (Ca), magnesium (Mg), elemental sulfur (S), neem oil, seaweed extract, bio-stimulants, char, ashes from incineration of animal waste or animal tissues, or any combination thereof.

The dried fertilizer composition containing the formed UCS adduct, can optionally be stored (e.g., not heated or mixed for a period of time) before granulation. The storage can occur in the same vessel used to produce the slurry, produce the dried fertilizer composition, and/or in the granulator. The storage can occur in a different vessel than that used to produce the slurry, produce the dried fertilizer composition, and/or can be different than the granulator. The dried fertilizer composition can be stored for any amount of time, such as 1 minute, 10 minutes, 30 minutes, 1 hour, 2 hours, 4 hours, 8 hours, 12 hours, 16 hours, 1 day, 2 days, 5 days, 1 week, 2 weeks, 3 weeks, 4 weeks, 1 month, 2 months, 3 months, 4 months, 5 months, 6 months, 1 year, 1 years, 5 years or more, or any amount of time or range thereof or there between. During the optional storage, the dried fertilizer composition can cool. In some instances, the dried fertilizer composition can cool during storage to ambient temperature, room temperature, −20° C., −10° C., 0° C., 10° C., 20° C., 25° C., 30° C., 35° C., 40° C., 45° C., 50° C., 55° C., 60° C., or any temperature or range thereof or there between. In some aspects, during the optional storage, UCS adduct formation can continue to occur in the dried fertilizer composition. In some instances, the dried fertilizer composition is stored for about 2 weeks before granulation. In some instances, the dried fertilizer composition is stored for 2 weeks or less before granulation. In some instances, the dried fertilizer composition is stored for at least 1 day before granulation. In some instances, the dried fertilizer composition is stored for 1 day to 2 weeks before granulation.

The granulator used for granulating the formed UCS adduct, such as the dried fertilizer composition containing the UCS adduct, and/or to produce the granulated fertilizer composition can be a granulation drum, pugmill, pan granulator, etc. The granulator can include a dryer or a dryer can be used after granulation.

The amount of water in the UCS adduct and/or granulated fertilizer composition after drying can be less than 0.6 wt. %, 0.5 wt. %, 0.4 wt. %, 0.3 wt. %, 0.2 wt. %, 0.1 wt. %, or less, or any amount or range thereof or there between. The amount of UCS adduct in the granulated fertilizer composition, UCS fertilizer and/or UCS fertilizer granules can be 40 wt. %, over 40 wt. %, over 45 wt. %, over 50 wt. %, over 55 wt. %, over 60 wt. %, over 65 wt. %, over 70 wt. %, over 75 wt. %, over 80 wt. %, over 85 wt. %, over 90 wt. %, or around 95 wt. %, or any amount or range thereof or there between. The granulated fertilizer composition, UCS fertilizer, and/or UCS fertilizer granules can optionally contain 0.2 wt. % to 7 wt. % of a base, such as MgO, and/or 0.01 wt. % to 0.2 wt. % of a urease inhibitor, such as NBPT. In some aspects, the granulated fertilizer composition, UCS fertilizer and/or UCS fertilizer granules can contain NBPT and MgO at a weight ratio of 0.03:1 to 0.06:3. In some aspects, forming the granulated fertilizer composition in the granulator and/or forming a UCS containing fertilizer can include adding of additional urea, additional calcium sulfate, additional phosphogypsum, additional UCS adduct, additional water, and aqueous solution, and/or one or more additives into or coating the granule and/or fertilizer. In some instances, the additional water can be added in the form of steam. The aqueous solution can in some instances be a scrubber solution. The scrubber solution can be acidic, contain ammonia, and/or contain a source of nitrogen, phosphorous, and/or potassium. In some instances, the scrubber solution is scrubber solution for scrubbing or that has already been used for scrubbing dryer air and/or reducing dust particles from production of a fertilizer, such as the UCS fertilizer granule, and/or a nitrogen (N), phosphorous (P), and/or potassium (K) (e.g., NP, NK, or NPK) fertilizer. The additive can be a fertilizer, a micronutrient, a secondary nutrient, or an organic agent. The additive can be a fertilizer, compound, or composition that provides a nitrogen based fertilizer, a phosphate-based fertilizer, a potassium-based fertilizer, a urea-based fertilizer, a fertilizer providing nitrogen-phosphorus-potassium (NPK), diammonium phosphate (DAP), monoammonium phosphate (MAP), single superphosphate (SSP), triple superphosphate (TSP), urea, potassium chloride, potassium sulfate, magnesium sulfate, superphosphates, rock phosphate, potash, sulfate of potash (SOP), muriate of potash (MOP), kieserite, carnallite, magnesite, dolomite, boric acid, boron (B), copper (Cu), iron (Fe), manganese (Mn), molybdenum (Mo), zinc (Zn), selenium (Se), silicon (Si), free Ca, magnesium (Mg), elemental sulfur (S), neem oil, seaweed extract, bio-stimulants, char, ashes from incineration of animal waste or animal tissues, or any combination thereof.

In some aspects, the process of forming the granulated fertilizer and/or UCS fertilizer composition can include adding a coating on the surface of the UCS fertilizer and/or granules. In some instances, the coating can contain nutrients for a plant, inhibitors of urea hydrolysis and/or nitrification, agents to slow or increase the rate of degradation of the granule, agents to repel moisture and/or provide a hydrophobic layer, agents that decrease or increase the reactivity of the granule, agents that provide additional benefits to plants, agents that increase the stability and/or crush strength of the granule, pH buffering agents, drying agents, etc. or any combination thereof. Non-limiting examples of a coating include a commercially available coating, an oil, a fertilizer, a micronutrient, talc, a seaweed and/or seaweed extract, a wax, etc. In some instances, the coating can contain surfactants. In some instances, the coating contains a wax, surfactants, and/or an amine-based compound. The coating can be applied to the granule before drying, during drying of the granule, or after drying of the granule. The coating can be applied to the granule by spraying, pouring, mixing, blending, etc. A fluid bed sprayer or coater, a liquid spray mixer, a rotating drum or pan, spray coating at discharge point, a paddle mixer, etc. can be used.

One aspect of the present invention is directed to a slurry and/or a fertilizer composition formed by the methods of the current invention. The slurry can contain 10 wt. % to 30 wt. % of water and 60 wt. % to 80 wt. % of the UCS adduct. The fertilizer composition can include 40 wt. % to 95 wt. % or 55 wt. % to 95 wt. % of the UCS adduct. In another aspects, a granulated fertilizer composition containing the formed UCS adduct is described. The granulated fertilizer composition can contain UCS fertilizer granules. The UCS fertilizer granule can include a UCS adduct, formed according to a method of the present invention. The UCS adduct can be CaSO₄·4CO(NH₂)₂. In some instances, the granule contains over 55 wt. %, over 60 wt. %, over 65 wt. %, over 70 wt. %, over 75 wt. %, over 80 wt. % over 85 wt. %, over 90 wt. %, or around 95 wt. % of the UCS adduct. Urea and calcium sulfate can be sufficiently separated in the granule when 40 wt. %, 55 wt. %, 60 wt. %, 65 wt. %, 70 wt. % or more of granule is UCS adduct, making the granules stable for long term storage. The UCS fertilizer granule and/or UCS fertilizer can contain less than 0.6 wt. % water, less than 0.5 wt. %, less than 0.4 wt. %, less than 0.3 wt. %, less than 0.2 wt. %, less than 0.1 wt. % water, or any amount or range thereof or there between.

In some instances, the granule and/or fertilizer can have a density greater than water (e.g., greater than 1.0 g/mL). The UCS fertilizer granule and/or UCS fertilizer can be comprised of one or more particles. Also, the UCS fertilizer granules and/or UCS fertilizers of the present invention can have an average particle size of 1 millimeter (mm) to 5 mm, preferable about 2 mm to 4 mm.

In some aspects, the UCS fertilizer granule and/or UCS fertilizer can include a coating on the surface of the granule. In some instances, the coating can include nutrients for a plant, inhibitors of urea hydrolysis and/or nitrification, agents to slow or increase the rate of degradation of the granule and/or fertilizer, agents to repel moisture and/or provide a hydrophobic layer, agents that decrease or increase the reactivity of the granule and/or fertilizer, agents that provide additional benefits to plants, agents that increase the stability and/or crush strength of the granule and/or fertilizer, pH buffering agents, drying agents, etc. or any combination thereof. The coating can be a commercially available coating, an oil, a fertilizer, a micronutrient, talc, a seaweed and/or seaweed extract, a wax, etc. In some instances, the coating can contain surfactants. In some instances, the coating contains a wax, surfactants, and/or an amine-based compound.

Also disclosed in the context of the present invention are blended or compounded fertilizer compositions that include a plurality of UCS fertilizer granules or UCS fertilizers of the present invention mixed with other fertilizers, micronutrients, secondary nutrients, or organic agents. The other fertilizers can be particulate in form (e.g., urea, monoammonium phosphate (MAP), diammonium phosphate (DAP), muriate of potash (MOP), and/or sulfate of potash (SOP)). The UCS granules and other fertilizers, micronutrients, secondary nutrients, or organic agents can be compatible with each other (e.g., can contact each other without having a chemical reaction take place). The blended or compounded fertilizer can contain in addition to the UCS fertilizer granules, a nitrogen based fertilizer, a phosphate-based fertilizer, a potassium-based fertilizer, a urea-based fertilizer, a fertilizer providing nitrogen, phosphorus, and potassium (NPK), diammonium phosphate (DAP), monoammonium phosphate (MAP), single superphosphate (SSP), triple superphosphate (TSP), urea, potassium chloride, potassium sulfate, magnesium sulfate, superphosphates, rock phosphate, potash, sulfate of potash (SOP), muriate of potash (MOP), kieserite, carnallite, magnesite, dolomite, boric acid, B, Cu, Fe, Mn, Mo, Zn, Se, Si, Ca, Mg, S, neem oil, seaweed extract, bio-stimulants, char, ashes from incineration of animal waste or animal tissues, etc., or any combination thereof.

In another aspect of the present invention, methods of fertilizing are described. A method can include applying a plurality of UCS fertilizer granules, a UCS fertilizers, and/or blended or compounded fertilizer compositions of the present invention to a portion of a soil, a crop, or a combination of the soil and the crop. In some embodiments, the soil is at least partially or fully submerged under water (e.g., rice paddy crops) and the granules sink in the water to contact the soil.

Another aspect of the present invention is directed to a system for producing a urea calcium sulfate (UCS) adduct. The system can include a phosphogypsum production system, such as a phosphoric acid production system, and a urea-phosphogypsum mixing vessel. The phosphoric acid production system can be configured to produce phosphoric acid and phosphogypsum, using rock phosphate. The phosphoric acid production system can be a system known in the art capable of producing phosphoric acid and phosphogypsum from rock phosphate. The phosphogypsum produced can be a moist phosphogypsum containing 10 wt. % to 30 wt. % of water. The urea-phosphogypsum mixing vessel, can be configured to receive urea and the moist phosphogypsum such as freshly produced moist phosphogypsum from the phosphoric acid production system, and contact the urea with the moist phosphogypsum to form a slurry containing a formed UCS adduct. The freshly produced moist phosphogypsum can have a moisture content of 10 wt. % to 30 wt. % or 15 wt. % to 30 wt. % and a temperature of 30° C. to 60° C. The freshly produced moist phosphogypsum after being formed in the phosphoric acid production system and/or plant is not pretreated, e.g. dried to reduce moisture content below 10 wt. % and/or cooled to a temperature below 30° C., prior to contacting the moist phosphogypsum with urea to form the slurry. In some aspects, the system can further include a dryer, configured to receive the slurry from the urea-phosphogypsum mixing vessel and dry the slurry to form a dried fertilizer composition containing the formed UCS adduct. The dryer can be a known dryer in the art. In some aspects, the system can further include a granulator configured to receive the dried fertilizer composition and/or UCS containing slurry, and granulate to form a granulated fertilizer composition containing the formed UCS adduct. The granulator can be a known granulator in the art such as granulation drum, pugmill, pan granulator, etc.

The following includes definitions of various terms and phrases used throughout this specification.

The term “fertilizer” is defined as a material applied to soils or to plant tissues to supply one or more plant nutrients essential or beneficial to the growth of plants and/or stimulants or enhancers to increase or enhance plant growth. Non-limiting examples of fertilizers include materials having one or more of urea, ammonium nitrate, calcium ammonium nitrate, urea calcium sulfate adduct, one or more superphosphates, binary NP fertilizers, binary NK fertilizers, binary PK fertilizers, NPK fertilizers, molybdenum, zinc, copper, boron, cobalt, and/or iron. In some aspects, fertilizers include agents that enhance plant growth and/or enhance the ability for a plant to receive the benefit of a fertilizer, such as, but not limited to biostimulants, urease inhibitors, and nitrification inhibitors.

The term “micronutrient” is defined as a chemical element or substance used in trace amounts for the normal growth and development of a plant. Non-limiting examples of micronutrients include B, Cu, Fe, Mn, Mo, Zn, Se, and Si or compounds thereof.

The term “secondary nutrient” is defined as a chemical element or substance used in moderate amounts for plant growth and are less likely to limit crop growth in comparison to N, P, and K. Non-limiting examples of secondary nutrients include Ca, Mg, and S.

The term “organic agent” is defined as a substance that is produced by or part of an organism. Non-limiting examples of organic agents suitable for a fertilizer include neem oil, seaweed extract, bio-stimulants, char, ashes from incineration of animal waste or animal tissues, and diatomaceous earth.

The term “granule” can include a solid material. A granule can have a variety of different shapes, non-limiting examples of which include a spherical, a puck, an oval, a rod, an oblong, or a random shape.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol. %,” or “mol. %” refers to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps.

The UCS fertilizer and methods of producing the UCS fertilizer of the present invention can “comprise,” “consist essentially of,” or “consist of” particular ingredients, components, compositions, steps, etc. disclosed throughout the specification. With respect to the transitional phase “consisting essentially of,” in one non-limiting aspect, a basic and novel characteristic of the UCS fertilizer of the present invention is the presence of a urea-calcium sulfate (UCS) adduct in the UCS fertilizer. Further, the process for producing the UCS adduct can in some instances include contacting urea with moist phosphogypsum.

In the context of the present invention, at least the following 20 aspects are described.

Aspect 1 is directed to a method for producing a urea calcium sulfate (UCS) adduct, the method comprising: (a) contacting urea with a moist phosphogypsum comprising 10 wt. % to 30 wt. % of moisture, under conditions sufficient to form a slurry comprising formed UCS adduct.

Aspect 2 is directed to the method of aspect 1, wherein an aqueous urea solution is contacted with the moist phosphogypsum to form the slurry.

Aspect 3 is directed to the method of any one of aspects 1 or 2, wherein the formed slurry comprising formed UCS adduct comprises 10 wt. % to 30 wt. % of water.

Aspect 4 is directed to the method of any one of aspects 1 to 3, wherein urea particles having a size of 0.1 mm to 1 mm are contacted with the moist phosphogypsum to form the slurry.

Aspect 5 is directed to the method of any one of aspects 1 to 4, wherein urea granules and/or prills having a size of 1 mm to 4 mm are contacted with the moist phosphogypsum to form the slurry.

Aspect 6 is directed to the method of any one of aspects 1 to 5, wherein the contacting conditions in step (a) include a temperature of 40° C. to 80° C.

Aspect 7 is directed to the method of any one of aspects 1 to 6, wherein the moist phosphogypsum contacting the urea has a temperature of 30° C. to 60° C.

Aspect 8 is directed to the method of any one of aspects 1 to 7, further comprising obtaining the moist phosphogypsum from a phosphoric acid manufacturing plant prior to step (a).

Aspect 9 is directed to the method of aspect 8, wherein:
i) the moist phosphogypsum produced from the phosphoric acid manufacturing plant is not dried and/or pretreated to reduce moisture content of moist phosphogypsum below 10 wt. % prior to contacting the urea in step (a) and/or
ii) wherein no water is added to the moist phosphogypsum produced from the phosphoric acid manufacturing plant after production of the phosphogypsum or in the contacting step (a) other than the water contained in the moist phosphogypsum from the phosphoric acid manufacturing plant.

Aspect 10 is directed to the method of any one of aspects 8 or 9, wherein the moist phosphogypsum produced from the phosphoric acid manufacturing plant is not cooled to a temperature below 30° C. prior to contacting the urea in step (a).

Aspect 11 is directed to the method of any one of aspects 1 to 10, wherein a molar ratio of urea contacting the moist phosphogypsum to calcium sulfate contained in the moist phosphogypsum contacted in step (a) is 1:0.25 to 1.2:0.16.

Aspect 12 is directed to the method of any one of aspects 1 to 11, further comprising: (b) drying the slurry to form a dried fertilizer composition comprising the formed UCS adduct.

Aspect 13 is directed to the method of aspect 12, wherein the dried fertilizer composition comprises 0 wt. % to 10 wt. %, or 0 wt. % to 2 wt. %, or 2 wt. % to 10 wt. % of moisture.

Aspect 14 is directed to the method of any one of aspects 12 or 13, wherein the drying in step (b) comprises contacting the slurry or a dryer used for drying the slurry with steam.

Aspect 15 is directed to the method of any one of aspects 12 to 14, wherein 40 wt. % to 95 wt. % of the dried fertilizer composition is comprised of the formed UCS adduct.

Aspect 16 is directed to the method of any one of aspects 1 to 15, further comprising granulating the formed UCS adduct before, during, and/or after drying the slurry.

Aspect 17 is directed to the method of aspect 16, wherein the granulating is performed in a granulator and step (a) is performed in a vessel different from the granulator.

Aspect 18 is directed to the method of any one of aspects 16 or 17, wherein the granulating comprises contacting the formed UCS with steam or the granulator used for granulating the formed UCS with steam.

Aspect 19 is directed to the method of any one of aspects 1 to 18, wherein the slurry of step (a) further comprises a base and/or a urease inhibitor.

Aspect 20 is directed to the method of any one of aspects 1 to 19, wherein the method further comprises combining the formed UCS adduct with at least one additional fertilizer to form a fertilizer blend and/or compounded fertilizer.

### BRIEF DESCRIPTION OF THE DRAWINGS

Advantages of the present invention may become apparent to those skilled in the art with the benefit of the following detailed description and upon reference to the accompanying drawings.

FIGS. 1A-1C are: FIG. 1A a schematic of a system according to one embodiment of the present invention to produce UCS fertilizer granules from urea and moist phosphogypsum; FIG. 1B a schematic of a system according to another embodiment of the present invention to produce UCS fertilizer granules from urea and moist phosphogypsum where, the moist phosphogypsum is freshly obtained from a phosphoric acid production plant; FIG. 1C a schematic of a system according to another embodiment of the present invention to produce UCS fertilizer granules from urea and moist phosphogypsum where the moist phosphogypsum is freshly obtained from a phosphoric acid production plant and an optional storage of the produced UCS step is included before granulation.

FIG. 2: A UCS fertilizer granule containing at least 80 wt. % UCS produced according to one method of the present invention from urea and moist phosphogypsum. The dark grey area on the granule shows unreacted urea, the white area on the granule shows unreacted gypsum and the light grey area on the granule shows UCS adduct.

FIG. 3: A UCS fertilizer granule containing 30 to 40 wt. % UCS adduct. The dark grey area on the granule shows unreacted urea, the white area on the granule shows unreacted gypsum and the light grey area on the granule shows UCS adduct.

While the invention is susceptible to various modifications and alternative forms, specific embodiments thereof are shown by way of example in the drawings. The drawings may not be to scale.

### DETAILED DESCRIPTION OF THE INVENTION

A process for producing a UCS fertilizer granule is disclosed. The UCS fertilizer granule can be produced from moist phosphogypsum. In some aspects, an UCS adduct can be formed from urea and freshly produced moist phosphogypsum from phosphoric acid manufacturing. In some aspects, the formed UCS adduct can be granulated to form UCS fertilizer granules.

The process of the current invention can provide for an economic method to produce a stable and high quality UCS adduct from moist phosphogypsum.

The UCS adduct of the present invention can be produced by the following non-limiting reaction:

CaSO₄·2H₂O+4CO(NH₂)₂→CaSO₄·4CO(NH₂)₂+2H₂O (1)

These and other non-limiting aspects of the present invention are discussed in further detail in the following sections.

A. Process to Produce UCS Fertilizer Granules from Moist Phosphogypsum

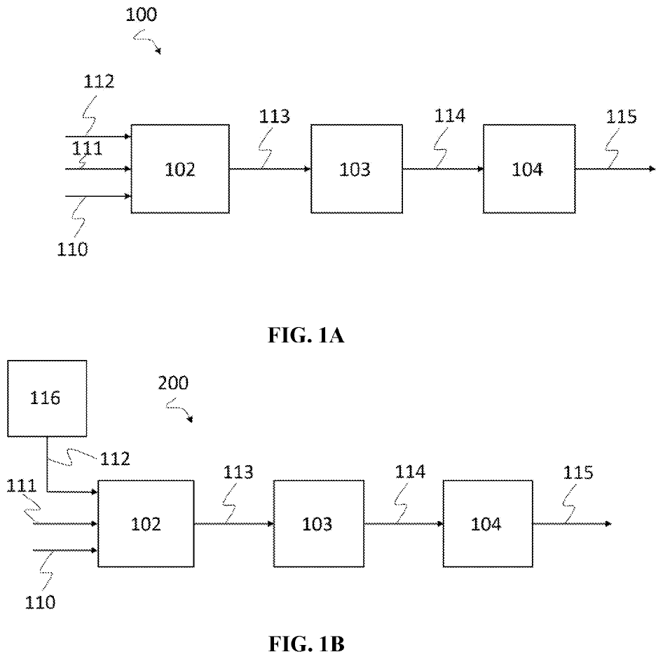

The UCS adduct and UCS granules of the present invention can be made using a system such as, but not limited to, systems 100, 200, and/or 300 shown in FIG. 1A, FIG. 1B, or FIG. 1C, respectively, or a combination thereof. The systems can be continuous processes or batch processes capable of handling slurries. Referring to FIG. 1A, FIG. 1B, or FIG. 1C, the systems 100, 200, and/or 300 can include a urea phosphogypsum mixing vessel 102. Urea 110 and moist phosphogypsum 112 can be fed to the vessel 102. In some aspects, urea in form of an urea solution can be fed to the vessel 102. In some aspects, the urea solution can contain 10 wt. % to 30 wt. % or at least one of, equal to any one of, or between any two of 10, 15, 20, 25 and 30 wt. % of water. In some aspects, urea in form of urea particles having a size of 0.1 mm to 1 mm or at least one of, equal to any one of, or between any two of 0.1, 0.2, 0.4, 0.6, 0.8 and 1 mm can be fed to the vessel 102. In some aspects, urea in form of urea granules and/or prills having a size of 1 mm to 4 mm or at least one of, equal to any one of, or between any two of 1, 2, 3 and 4 mm can be fed to the vessel 102. The moist phosphogypsum 112 fed to the vessel 102 can contain i) 10 wt. % to 30 wt. % or 15 wt. % to 30 wt. % or at least one of, equal to any one of, or between any two of 10, 12, 14, 16, 18, 20, 22, 24, 26, 28 and 30 wt. % of water e.g. moisture and ii) 65 wt. % to 88 wt. % or at least one of, equal to any one of, or between any two of 65, 66, 68, 70, 72, 74, 76, 78, 80, 82, 84, 86, and 88 wt. % of calcium sulfate. In some aspects, the phosphogypsum can further contain one or both of P₂O₅ and/or phosphoric acid with total amount of 0.5 wt. % to 5 wt. % or at least one of, equal to any one of, or between any two of 0.5, 1, 2, 3, 4, and 5 wt. %. The moist phosphogypsum 112 fed to the vessel 102 can have a temperature of 30° C. to 80° C. or 30° C. to 60° C. or 35° C. to 55° C. at least one of, equal to any one of, or between any two of 30, 35, 40, 45, 50, 55, 60, 65, 70, 75 and 80° C.

In some aspects, urea 110 and the moist phosphogypsum 112 can be fed to the vessel 102 separately. In some aspects, urea 110 and moist phosphogypsum 112 can be premixed (such as in a pre-mixing zone) before and can fed to the vessel as a combined feed (not shown). Optionally water 111 can be fed to the vessel 102. The optional water 111 can be different from water present in urea, such as moisture in the added urea particles, prills, or granules or water in the added urea solution, and water present in moist phosphogypsum, such as a moisture in the moist phosphogypsum. In some aspects, all or part of the optional water 111 can be premixed with the urea 110 and/or the moist phosphogypsum 112 and can be fed to the vessel as combined feed (not shown).

In the vessel 102, urea 110, moist phosphogypsum 112 and the optional water 111, can be combined to form a slurry containing a UCS adduct. In some aspects, the UCS adduct can be formed by the reaction 1. The water content of the slurry can be 10% to 50 wt. % or 10% to 30 wt. % or at least one of, equal to any one of, or between any two of 10, 12, 14, 16, 18, 20, 22, 24, 26, 28, 30, 32, 34, 36, 38, 40, 42, 44, 46, 48, and 50 wt. %. In some aspects, the vessel 102 can be a continuous stirred-tank reactor. Mixing (e.g., agitator rpm of between 40 to 60 RPM) can be used to promote formation of the UCS adduct and/or to decrease the amount of heat required for the formation. The vessel 102 may include a rotatable section, a rotatable internal container, and/or a section that vibrates. In some instances, the rotatable section and/or rotatable internal container may contain internal flights and/or be rotated to induce movement of the reactants (urea 110 and moist phosphogypsum 112). In some aspects, molar ratio of the urea fed to the vessel 102 to calcium sulfate contained in the moist phosphogypsum fed to the vessel 102 can be 1:0.25 to 1.2:0.16 or at least one of, equal to any one of, or between any two of 1:0.25, 1.1:0.2, and 1.2:0.16.

Urea dissolution is an endothermic process. Optionally, the temperature of the vessel 102 can be increased to 1) increase the formation of the UCS adduct, 2) decrease the amount of water 111 needed, and/or 3) decrease the viscosity of the aqueous slurry. In some aspects, urea 110 and the moist phosphogypsum 112 can be contacted at 40° C. to 100° C. or 40° C. to 80° C. or at least one of, equal to any one of, or between any two of 40, 45, 50, 55, 60, 65, 70, 75, 80, 85, 90, 95 and 100° C. in the vessel 102 to form the slurry. Heat can be provided by any means suitable or known. In some instances, steam can be used. The optional use of steam can inhibit absorption of heat from the surroundings and hence lower the temperature requirement in the vessel 102 without additional energy. With steam injection, the urea can be rapidly dissolved while the surrounding material is maintained at the high temperature, which can preferably be about 40° C. to 100° C. or 60° C. to 100° C. or 40° C. to 80° C. or any range or value therein. Additional active or inactive ingredients can be added to the slurry while in the vessel 102 or at any other time.

In some aspects, the slurry 113 containing UCS can exit the vessel 102 and enter an optional second mixing and stabilizing zone where additional UCS such as recycle UCS, additional urea, additional phosphogypsum, calcium sulfate, an additive or inactive ingredients, or any combination thereof can be added to the slurry 113 (not shown). The slurry 113 exiting the vessel 102 or the optional second mixing and stabilizing zone can typically contain more than 10 wt. % water. The slurry 113 can optionally contain a urease inhibitor and/or a base. In some aspects, the optional urease inhibitor and/or the base can added to the vessel 102 with a separate stream (not shown), and/or can be added with the urea 110, moist phosphogypsum 112, and/or the optional water 111 stream(s). In some aspects, the optional urease inhibitor and/or the base can added to the optional second mixing and stabilizing zone. The base can contain an oxide, carbonate, acetate, and/or hydroxide of a group 1 metal, group 2 metal, group 13 metal, and/or ammonium. In certain aspects, the base can contain CaO and/or MgO. In certain particular aspects, the base can be MgO. In certain aspects, the base such as MgO can be comprised in particulate solids. In certain aspects, the particulate solids can have an average diameter of 0.1 μm to 150 μm or 1 μm to 50 μm. In certain aspects, the urease inhibitor can contain a thiophosphoric triamide derivative or phenyl phosphorodiamidate (PPDA). In certain aspects, the thiophosphoric triamide derivative can be N-(n-butyl) thiophosphoric triamide (NBPT).

The slurry 113 from the vessel 102, or the optional second mixing and stabilizing zone if used, can be fed to a dryer 103. In the dryer 103, the slurry can be dried to form a dried fertilizer composition containing the formed UCS adduct. The dryer 103 can be a part or function of the vessel 102 (not shown) or can be separate. Heat for drying can be provided by any means suitable or known. In some embodiments, the dryer 103 can be heated by steam (not shown), such as in steam jacketed dryer. The dried fertilizer composition 114 exiting the dryer 103 can contain 0 wt. % to 10 wt. %, or 0 wt. % to 2 wt. %, or 2 wt. % to 10 wt. % or at least one of, equal to any one of, or between any two of 0, 1, 2, 3, 4, 5, 6, 7, 8, 9 and 10 wt. % of moisture. The slurry can be dried in the dryer at a temperature 35° C. to 100° C. or at least one of, equal to any one of, or between any two of 35° C., 40° C., 45° C., 50° C., 55° C., 60° C., 65° C., 70° C., 75° C., 80° C., 85° C., 90° C., 95° C. and 100° C. to form the dried fertilizer composition.

The dried fertilizer composition 114 formed in the dryer 103 can be granulated in a granulator 104 to form a granulated fertilizer composition 115 containing the formed UCS adduct. The granulated fertilizer composition 115 can contain UCS fertilizer granules containing the formed UCS adduct. In some aspects, the granulator 104 can be separate from the vessel 102 and the dryer 103. In some aspects, the vessel 102, the dryer 103 and the granulator 104 can be the same vessel or part of a same vessel. The granulator 104, may include a rotatable section, a rotatable internal container, and/or a section that vibrates. In some instances, the rotatable section and/or rotatable internal container may contain internal flights and/or be rotated to induce movement of the dried fertilizer composition 114 in the granulator 104. The granulator 104 can be or can be part of a granulation drum, pugmill, pan granulator, etc. In some aspects, 40 wt. % to 95 wt. % or 55 wt. % to 95 wt. % or at least one of, equal to any one of, or between any two 40, 45, 50, 55, 60, 65, 70, 75, 80, 85, 90 and 95 wt. % of the dried fertilizer composition 114 and/or the granulated fertilizer composition 115 can be comprised of the UCS adduct. The granulated fertilizer composition 115 can optionally contain 0.2 wt. % to 7 wt. % or at least any one of, equal to any one of, or between any two of 0.2 wt. %, 0.5 wt. %, 1 wt. %, 2 wt. %, 3 wt. %, 4 wt. %, 5 wt. %, 6 wt. %, 7 wt. % of a base, such as MgO. The granulated fertilizer composition 115 can optionally contain 0.01 wt. % to 0.2 wt. % or at least any one of, equal to any one of, or between any two of 0.01 wt. %, 0.05 wt. %, 0.1 wt. %, 0.15 wt. % and 0.2 wt. % of a urease inhibitor, such as NBPT. In some aspects, granulated fertilizer composition 115 can contain NBPT and MgO at a weight ratio of 0.03:1 to 0.06:3 or at least any one of, equal to any one of, or between any two of 0.03:1, 0.06:1, 0.06:1.5, 0.06:2, 0.06:2.5, and 0.06:3.

Optionally, water or an aqueous solution, such as steam and/or a scrubber solution, can be combined with the dried fertilizer composition 114 in the granulator 104 to facilitate granulation of the dried fertilizer composition 114 (not shown). Optionally additional UCS such as recycled UCS, additional urea, additional phosphogypsum, calcium sulfate or one or more additives or any combination thereof can be added to the material in the granulator 104 (not shown).

Optionally the granulated fertilizer composition can be further dried after granulation (not shown). The further drying can occur in a further drying zone that can be a dryer and/or part of or a function of the granulator 104 or the vessel 102. In some aspects, the dried fertilizer composition 114 can granulated and further dried at the same time, such as in a rotating dryer.

Optionally the UCS fertilizer and/or UCS fertilizer granules can be coated with one or more coating material to form coated UCS fertilizer granules.

Referring to FIG. 1B and FIG. 1C, in some embodiments, the moist phosphogypsum 112 can be obtained from a phosphoric acid production system 116. The phosphoric acid production system 116 can produce the moist phosphogypsum 112 and phosphoric acid (not shown) from rock phosphate (not shown). In some aspects, the moist phosphogypsum 112, can be a freshly produced moist phosphogypsum from the phosphoric acid production system 116. As used herein “freshly produced moist phosphogypsum” can refer to phosphogypsum produced from the phosphoric acid production system that has not been dried to reduce the moisture content below 10 wt. % and/or cooled to reduce the temperature below 30° C., prior to contacting the phosphogypsum with urea. The freshly produced moist phosphogypsum can have a moisture content of 10 wt. % to 30 wt. % or 15 wt. % to 30 wt. %, a temperature of 30° C. to 80° C. or 30° C. to 60° C. or 35° C. to 55° C. and pH (of 10 wt. % aqueous solution) of 1.5 to 4 or 2 to 3. In some aspects, the freshly produced moist phosphogypsum can have a moisture content of 15 wt. % to 30 wt. %, a temperature of 35° C. to 55° C. and pH (of 10 wt. % aqueous solution) of 2 to 3. The pH of the freshly produced moist phosphogypsum can be measured in a 10 wt. % of aqueous solution, e.g., 10 gm of moist phosphogypsum in 100 gm of solution.

Optionally, the dried UCS fertilizer composition 114 can be stored before granulation (FIG. 1C). During storage, in some instances, the dried fertilizer composition 114 is not continuously mixed or actively heated to temperatures above ambient temperature (e.g., the dried fertilizer composition 114 can sit in a container located in a storage facility). The dried fertilizer composition 114 can be stored in a storage container 118. The storage container 118 can be part of the vessel 102 (not shown) or can be part of the dryer 103 (not shown) and/or part of the granulator 104, or can be separate from the first vessel 102, dryer 103, or granulator 104. In some aspects, storage container 118 can be a part of the vessel 102, the dryer 103, or granulator 104 while these are not mixing or actively heating (not shown). In some aspects, if stored, the dried fertilizer composition 114 after storage can be fed to the granulator 104 to form the granulated fertilizer composition 115 containing the formed UCS adduct.

In some embodiments, additional UCS such as recycle UCS, additional urea, additional phosphogypsum, calcium sulfate, or an additive can be added to a one or more process steps to help maintain consistency of the mixture, or provide beneficial properties to the slurry, dried UCS fertilizer composition, and/or UCS fertilizer granule.

### B. UCS Fertilizer Granules

The UCS fertilizer granule produced can, in some instances, contain low amounts of moisture. The free-moisture content of the granule can be less than 0.6 wt. %, less than 0.5 wt. % water or 0.25 wt. % to less than 0.6 wt. % water. In some instances, the free moisture content is 0.5, 0.4, 0.3, 0.2, 0.1, or 0 wt. %.

The granule can be comprised of one or more particles. In some aspects, a first portion of the particles can be the UCS adduct. In certain non-limiting aspects, the first portion of the particles can have an average particle size of 1, 2, 3, 4, 5, 6, 7, 8, 9, 10, 11, 12, 13, 14, 15, 20, 30, 40, 50, 60, 70, 80, 90, 100, 200, 300, 400, 500, 600, 700, 800, or 900 micrometers or any size there between. In some embodiments, the particles can be elongated particles or can be substantially spherical particles or other shapes, or combinations of such shapes. Non-limiting examples of shapes include a sphere, a puck, an oval, a rod, an oblong, or a random shape. In some aspects, 40 wt. % to 95 wt. % or 55 wt. % to 95 wt. % or at least one of, equal to any one of, or between any two 40, 45, 50, 55, 60, 65, 70, 75, 80, 85, 90 and 95 wt. % of the UCS granules can be comprised of the UCS adduct.

The UCS granules can have a crush strength of 1, 2, 3, 4, 5, 6, 7, 8, 9, 10 kgf/granule, or more, or any amount there between, preferably 2 kgf/granule to 5 kgf/granule.

The UCS granules and/or UCS fertilizers can in some instances contain a coating on the surface of the UCS granule and/or UCS fertilizers. In some instances, the coating can include nutrients for a plant, inhibitors of urea hydrolysis and/or nitrification, agents to slow or increase the rate of degradation of the granule and/or fertilizers, agents to repel moisture and/or provide a hydrophobic layer, agents that decrease or increase the reactivity of the granule and/or fertilizers, agents that provide additional benefits to plants, agents that increase the stability and/or crush strength of the granule and/or fertilizers, pH buffering agents, drying agents, etc. or any combination thereof. The coating can be a commercially available coating, an oil, a fertilizer, a micronutrient, talc, a seaweed and/or seaweed extract, a wax, etc. In some instances, the coating can contain surfactants. In some instances, the coating contains a wax, surfactants, and/or an amine-based compound.

### C. Blended or Compounded Fertilizer Compositions

The UCS adduct and/or the UCS fertilizer granules of the present invention can also be included in a blended or compounded fertilizer composition comprising other fertilizers, such as other fertilizer granules. Additional fertilizers can be chosen based on the particular needs of certain types of soil, climate, or other growing conditions to maximize the efficacy of the UCS in enhancing plant growth and crop yield. The other fertilizer granules can be granules of urea, single super phosphate (SSP), triple super phosphate (TSP), ammonium sulfate, monoammonium phosphate (MAP), diammonium phosphate (DAP), muriate of potash (MOP), and/or sulfate of potash (SOP), and the like.

The UCS adduct and/or UCS granules can be used alone or in combination with other fertilizer actives and micronutrients. In some aspects, the other fertilizer actives and micronutrients can be added with any of the ingredients at the beginning of the drying stage or granulation process or at any later stage.

Non-limiting examples of additional additives can be micronutrients, primary nutrients, and secondary nutrients. A micronutrient is a botanically acceptable form of an inorganic or organometallic compound such as boron, copper, iron, chloride, manganese, molybdenum, nickel, or zinc. A primary nutrient is a material that can deliver nitrogen, phosphorous, and/or potassium to a plant. Nitrogen-containing primary nutrients may include urea, ammonium nitrate, ammonium sulfate, diammonium phosphate, monoammonium phosphate, urea-formaldehyde, or combinations thereof. A secondary nutrient is a substance that can deliver calcium, magnesium, and/or sulfur to a plant. Secondary nutrients may include lime, gypsum, superphosphate, or a combination thereof. For example, in some instances the UCS granule can contain calcium sulfate, potassium sulfate, magnesium sulfate or a combination thereof.

In one aspect, the UCS adduct containing fertilizer compositions, and/or UCS granules can comprise one or more inhibitors. The inhibitor can be a urease inhibitor or a nitrification inhibitor, or a combination thereof. In one aspect, a urease inhibitor and a nitrification inhibitor are included. In one aspect, the inhibitor can be a urease inhibitor. Suitable urease inhibitors include, but are not limited to, N-(n-butyl) thiophosphoric triamide (NBTPT) and phenylphosphorodiamidate (PPDA). In one aspect, the UCS fertilizer granule and/or UCS fertilizer can comprise NBTPT or PPDA, or a combination thereof. In another aspect, the inhibitor can be a nitrification inhibitor. Suitable nitrification inhibitors include, but are not limited to, 3,4-dimethylpyrazole phosphate (DMPP), dicyandiamide (DCD), thiourea (TU), 2-chloro-6-(trichloromethyl)-pyridine (Nitrapyrin), 5-ethoxy-3-trichloromethyl-1,2,4-thiadiazol, which is sold under the tradename Terrazole®, by OHP Inc., USA, 2-amino 4-chloro 6-methyl pyrimidine (AM), 2-mercaptobenzothiazole (MBT), or 2-sulfanilamidothiazole (ST), and any combination thereof. In one aspect, a nitrification inhibitor can comprise DMPP, DCD, TU, nitrapyrin, 5-ethoxy-3-trichloromethyl-1,2,4-thiadiazol, AM, MBT, or ST, or a combination thereof. In one aspect, the UCS fertilizer granule and/or UCS fertilizer can comprise NBTPT, DMPP, TU, DCD, PPDA, nitrapyrin, 5-ethoxy-3-trichloromethyl-1,2,4-thiadiazol, AM, MBT, or ST, or a combination thereof.

### D. Method of Using the UCS Fertilizer Granules

The UCS adduct and/or UCS fertilizer granules of the present invention can be used in methods of increasing the amount of nitrogen in soil and of enhancing plant growth. Such methods can include applying to the soil an effective amount of a composition comprising the UCS adduct and/or UCS fertilizer granule of the present invention. The method may include increasing the growth and yield of crops, trees, ornamentals, etc. such as, for example, palm, coconut, rice, wheat, corn, barley, oats, and soybeans. The method can include applying the UCS adduct and/or UCS fertilizer granules of the present invention to at least one of a soil, an organism, a liquid carrier, a liquid solvent, etc.

Non-limiting examples of plants that can benefit from the fertilizer of the present invention include vines, trees, shrubs, stalked plants, ferns, etc. The plants may include orchard crops, vines, ornamental plants, food crops, timber, and harvested plants. The plants may include Gymnosperms, Angiosperms, and/or Pteridophytes. The Gymnosperms may include plants from the Araucariaceae, Cupressaceae, Pinaceae, Podocarpaceae, Sciadopitaceae, Taxaceae, Cycadaceae, and Ginkgoaceae families. The Angiosperms may include plants from the Aceraceae, Agavaceae, Anacardiaceae, Annonaceae, Apocynaceae, Aquifoliaceae, Araliaceae, Arecaceae, Asphodelaceae, Asteraceae, Berberidaceae, Betulaceae, Bignoniaceae, Bombacaceae, Boraginaceae, Burseraceae, Buxaceae, Canellaceae, Cannabaceae, Capparidaceae, Caprifoliaceae, Caricaceae, Casuarinaceae, Celastraceae, Cercidiphyllaceae, Chrysobalanaceae, Clusiaceae, Combretaceae, Cornaceae, Cyrillaceae, Davidsoniaceae, Ebenaceae, Elaeagnaceae, Ericaceae, Euphorbiaceae, Fabaceae, Fagaceae, Grossulariaceae, Hamamelidaceae, Hippocastanaceae, Illiciaceae, Juglandaceae, Lauraceae, Lecythidaceae, Lythraceae, Magnoliaceae, Malpighiaceae, Malvaceae, Melastomataceae, Meliaceae, Moraceae, Moringaceae, Muntingiaceae, Myoporaceae, Myricaceae, Myrsinaceae, Myrtaceae, Nothofagaceae, Nyctaginaceae, Nyssaceae, Olacaceae, Oleaceae, Oxalidaceae, Pandanaceae, Papaveraceae, Phyllanthaceae, Pittosporaceae, Platanaceae, Poaceae, Polygonaceae, Proteaceae, Punicaceae, Rhamnaceae, Rhizophoraceae, Rosaceae, Rubiaceae, Rutaceae, Salicaceae, Sapindaceae, Sapotaceae, Simaroubaceae, Solanaceae, Staphyleaceae, Sterculiaceae, Strelitziaceae, Styracaceae, Surianaceae, Symplocaceae, Tamaricaceae, Theaceae, Theophrastaceae, Thymelaeaceae, Tiliaceae, Ulmaceae, Verbenaceae, and/or Vitaceae family.

The effectiveness of compositions comprising the UCS adduct and/or UCS fertilizer granules of the present invention can be ascertained by measuring the amount of nitrogen in the soil at various times after applying the fertilizer composition to the soil. It is understood that different soils have different characteristics, which can affect the stability of the nitrogen in the soil. The effectiveness of a fertilizer composition can also be directly compared to other fertilizer compositions by doing a side-by-side comparison in the same soil under the same conditions.

In one aspect, the UCS fertilizer granules and/or UCS fertilizer of the present invention can have a density that is greater than water. This can allow the granules and/or fertilizers to sink in water rather than float. This can be especially beneficial in instances where application is intended to a crop that is at least partially or fully submerged in water. A non-limiting example of such a crop is rice, as the ground in a rice paddy is typically submerged in water. Thus, application of UCS granules and/or UCS fertilizer to such crops can be performed such that the granules and/or fertilizer are homogenously distributed on the ground that is submerged under water. By comparison, granules and/or fertilizers that have a density that is less than water would have a tendency to remain in or on the water surface, which could result in washing away and/or coalescence of the granules and/or fertilizers, either of which would not achieve homogenous distribution of the granules and/or fertilizers to the ground that is submerged under water.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results

### Example 1

### Producing UCS Adduct and UCS Granules from Moist Phosphogypsum

Moist phosphogypsum and urea can be mixed in a vessel to form a slurry containing UCS adduct. Moist phosphogypsum having a composition as shown in Table 1 can be used. pH of an aqueous solution containing 10 wt. % of the moist phosphogypsum is 2.4.

Urea in form of urea solution, granules, prills, and/or powder can be added to the vessel.

TABLE 1
Composition of moist phosphogypsum.

| Component | wt. % |
|---|---|
| Free Moisture | 18.4 |
| Total P₂O₅/Water soluble P₂O₅ | 1.43/0.87 |
| CaSO₄ | 77.62 |
| SiO₂ | 1.83 |
| MgO | 0.01 |
| Fe₂O₃ | 0.01 |
| F | 0.32 |
| Na₂O | 0.18 |
| K₂O | 0.02 |
| Cd | 0.0001 |
| Cr | 0.0014 |
| Pb | 0.0002 |
| Sr | 0.08 |
| Al₂O₃ | 0.08 |

The temperature of the urea phosphogypsum mixture and/or slurry can be kept around 60° C. The vessel can be rotated at a speed around 5-10 RPM to mix/convert the urea/phosphogypsum to the slurry containing UCS adduct. The moisture content of the slurry can be kept to around 20 wt. % to obtain a wet consistency. A residence time in the reaction vessel can be 30 minutes.

The slurry can be dried at a temperature about 75° C. to 95° C., such as 90° C. to form a dried fertilizer composition containing the UCS adduct. The UCS adduct content of the dried fertilizer composition can be above 80 wt. % and the water content of the dried fertilizer composition can be less than about 10 wt. % water but above 0.5 wt. % water. The dried fertilizer composition can be in a Run of Pile form (ungranulated).

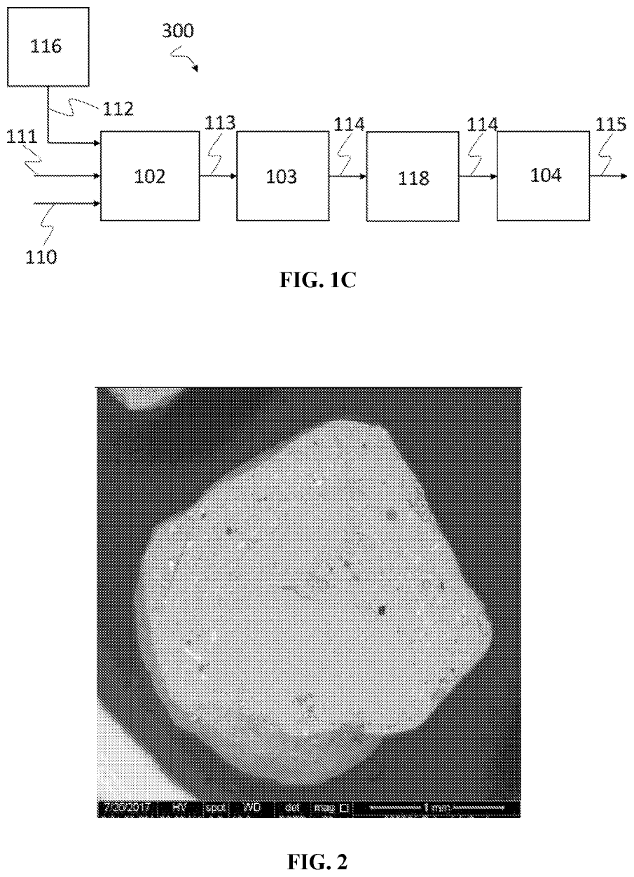

The dried fertilizer composition can then be granulated in a granulator to obtain a granulated fertilizer composition containing UCS fertilizer granules. The fertilizer composition can further be dried during granulation to moisture content 0.5 wt. %. The UCS adduct content of the granulated fertilizer composition can be about 80 wt. %. FIG. 2 shows a UCS fertilizer granule containing greater than 80 wt. % UCS adduct. The UCS fertilizer granules are expected to be able to be produced in any size required for fertilizer applications, such as spherical granules having a diameter of 5 mm and 5 cm. It was found urea and calcium sulfate can be sufficiently separated in the granule with 60 wt. % or more of UCS adduct. When the urea and calcium sulfate are sufficiently separated in the granule, the granule can have a long term storage life. In some instances, sufficiently separated can be when a cross section of the UCS granule under microscope shows clear demarcation of the unreacted urea and calcium sulfate. In some instances, sufficiently separated can be when UCS adduct and unreacted urea and gypsum regions can be distinguished under a microscope with 80× magnification.

If the UCS product is found to have nutrient levels that are slightly off specification, then minor adjustments in nutrient content can be achieved by adding fresh urea/phosphogypsum/calcium sulfate as solid to the granulating UCS.

In this example, to produce 20 MT/hr of UCS slurry (20 wt. % water), 9.4 MT/hr of urea, 10.6 MT/hr of moist phosphogypsum can be used. The UCS fertilizer granule can have 27 wt. % nitrogen (N), 7 wt. % sulfur (S), and 9 wt. % calcium (Ca).

### Example 2 (Comparative Example)

### Producing UCS Adduct and UCS Granules from Dried Phosphogypsum

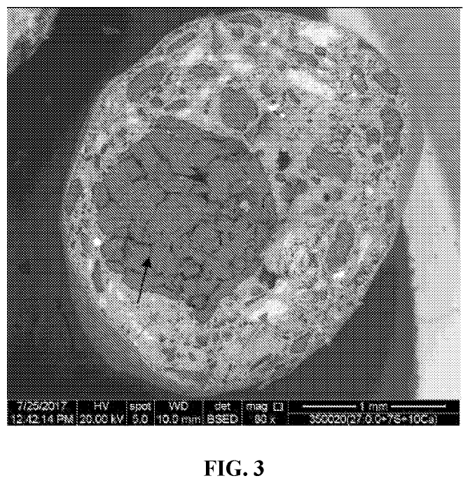

In a comparative example UCS fertilizer granules can be produced with a method similar to example 1, except phosphogypsum with moisture content 2-3 wt. % can be used instead of moist phosphogypsum and the moisture content of the slurry can be kept to around 2-3 wt. %. The composition of the phosphogypsum used for comparative Example 2 can be similar to Table 1, except free moisture content is 2-3 wt. %. The UCS adduct content of the granulated fertilizer composition produced in Example 2 was shown to be about 30 to less than 40 wt. %. FIG. 3 shows a UCS fertilizer granule containing 30 wt. % to less than 40 wt. % UCS. Urea and calcium sulfate are not sufficiently separated in the granule of Example 2, and the granule has less storage life compared to a granule of example 1.

1. A method for producing a urea calcium sulfate (UCS) adduct, the method comprising:
(a) contacting urea with a moist phosphogypsum comprising 10 wt. % to 30 wt. % of moisture, under conditions sufficient to form a slurry comprising formed UCS adduct.

2. The method of claim 1, wherein an aqueous urea solution is contacted with the moist phosphogypsum to form the slurry.

3. The method of claim 2, wherein the formed slurry comprising formed UCS adduct comprises 10 wt. % to 30 wt. % of water.

4. The method of claim 1, wherein urea particles having a size of 0.1 mm to 1 mm are contacted with the moist phosphogypsum to form the slurry.

5. The method of claim 1, wherein urea granules and/or prills having a size of 1 mm to 4 mm are contacted with the moist phosphogypsum to form the slurry.

6. The method of claim 1, wherein the contacting conditions in step (a) include a temperature of 40° C. to 80° C.

7. The method of claim 1, wherein the moist phosphogypsum contacting the urea has a temperature of 30° C. to 60° C.

8. The method of claim 1, further comprising obtaining the moist phosphogypsum from a phosphoric acid manufacturing plant prior to step (a).

9. The method of claim 8, wherein:
i) the moist phosphogypsum produced from the phosphoric acid manufacturing plant is not dried and/or pretreated to reduce moisture content of moist phosphogypsum below 10 wt. % prior to contacting the urea in step (a) and/or
ii) wherein no water is added to the moist phosphogypsum produced from the phosphoric acid manufacturing plant after production of the phosphogypsum or in the contacting step (a) other than the water contained in the moist phosphogypsum from the phosphoric acid manufacturing plant.

10. The method of claim 8, wherein the moist phosphogypsum produced from the phosphoric acid manufacturing plant is not cooled to a temperature below 30° C. prior to contacting the urea in step (a).

11. The method of claim 1, wherein a molar ratio of urea contacting the moist phosphogypsum to calcium sulfate contained in the moist phosphogypsum contacted in step (a) is 1:0.25 to 1.2:0.16.

12. The method of claim 1, further comprising:
(b) drying the slurry to form a dried fertilizer composition comprising the formed UCS adduct.

13. The method of claim 12, wherein the dried fertilizer composition comprises 0 wt. % to 10 wt. % of moisture.

14. The method of claim 12, wherein the drying in step (b) comprises contacting the slurry or a dryer used for drying the slurry with steam.

15. The method of claim 12, wherein 40 wt. % to 95 wt. % of the dried fertilizer composition is comprised of the formed UCS adduct.

16. The method of claim 1, further comprising granulating the formed UCS adduct before, during, and/or after drying the slurry.

17. The method of claim 16, wherein the granulating is performed in a granulator and step (a) is performed in a vessel different from the granulator.

18. The method of claim 17, wherein the granulating comprises contacting the formed UCS with steam or the granulator used for granulating the formed UCS with steam.

19. The method of claim 1, wherein the slurry of step (a) further comprises a base and/or a urease inhibitor.

20. The method of claim 1, wherein the method further comprises combining the formed UCS adduct with at least one additional fertilizer to form a fertilizer blend and/or compounded fertilizer.
